(19) United States
(12) Patent Application Publication
(10) Pub. No.: US 2016/0064778 A1
(43) Pub. Date: Mar. 3, 2016

(54) BATTERY HAVING AN INTERNAL TERMINAL DISCONNECT SWITCH

(71) Applicant: Lon Issac Bird, Torrington (CA)

(72) Inventor: Lon Issac Bird, Torrington (CA)

(21) Appl. No.: 14/938,792

(22) Filed: Nov. 11, 2015

Related U.S. Application Data
(63) Continuation-in-part of application No. 14/028,770, filed on Sep. 17, 2013.

(51) Int. Cl. H01M 10/42; H01H 15/02

(52) U.S. Cl. CPC H01M 10/425; H01H 15/02; H01H 2223/002; H01H 2223/044; H01H 2239/034

(57) ABSTRACT

A battery comprising an internal terminal disconnect switch for selectively preventing current flow from the motor vehicle battery, wherein the internal terminal disconnect switch comprises: a) an external battery post portion; b) an internal battery post portion; c) a housing; and d) a switch contact post capable of moving horizontally towards and between the external battery post portion and the internal battery post portion and making contact therebetween at a contact portion between the external battery post portion and the internal battery post portion, wherein contacting the external battery post portion and the internal battery post portion permits current flow from the battery.

### CROSS REFERENCE TO RELATED APPLICATION

This application is a continuation-in-part of applicant's co-pending application Ser. No. 14/028,770, filed Sep. 17, 2013, the entire contents of which is hereby expressly incorporated by reference herein.

### FIELD OF THE INVENTION

The present disclosure is in the field of batteries having an electrical disconnection switch.

### BACKGROUND OF THE DISCLOSURE

Motor vehicle batteries are known to discharge upon storage, thereby requiring recharging or replacement following storage for an extended time. In addition, motor vehicle batteries sometimes produce an explosion when a load is connected to the battery terminal. Battery disconnect switches are a known solution to the former problem. The present invention addresses both the former problem and the latter problem.

U.S. Pat. No. 6,744,344 discloses a disconnect switch for the load circuit of a vehicle battery which includes a movable contact element and a stationary contact element that are linked with a locking mechanism. For releasing the locking mechanism a shape-memory alloy release element is used that contracts when heated. For closing the locking mechanism a shape-memory alloy spring element is provided that induces closure of the mechanism by expansion.

U.S. Pat. No. 6,492,745 discloses a battery control system for controlling the connection of a plurality of batteries to a load. The system comprises a plurality of switches and a plurality of controllers. Each switch is operable to connect or disconnect one of the batteries from the load. Each controller is operatively coupled to one of the switches. Each controller is operative to cause one of the switches to disconnect one of the batteries from the load. Each controller has an input and an output for communicating with another controller wherein the controllers communicate with each other to limit the number of batteries that can be disconnected from the loads.

U.S. Pat. No. 6,049,140 discloses a manually reversible battery disconnection system for mounting directly on a terminal of a battery of a motor vehicle. The system includes a housing; a battery terminal connector secured to the housing; a normally closed electrical switch mounted inside the housing; an electrical conductor connected to the battery terminal connector and to one side of the switch; one or more fuses mounted inside the housing, and connected between the other side of the switch and output terminals mounted on the housing; a sensor for detecting an adverse condition; an electromagnetically operated device mounted inside the housing and electrically connected to the sensor, mechanically connected to the switch, and actuable on receipt of an adverse condition signal from the sensor to open the switch; and a manual control mounted on the housing and mechanically connected to the switch for manually operating the switch.

However, the aforementioned battery disconnect switches do not provide a sealed environment for establishing or preventing the point of contact with the battery terminal. Thus, there exists a need for a battery containing an internal terminal disconnect switch that provides a sealed, and therefore safe, contact point with the battery terminal.

### SUMMARY OF THE INVENTION

A battery comprising an internal terminal disconnect switch for selectively preventing current flow from the motor vehicle battery, wherein the internal terminal disconnect switch comprises: a) an external battery post portion; b) an internal battery post portion; c) a housing; and d) a switch contact post capable of moving horizontally towards and between the external battery post portion and the internal battery post portion and making contact therebetween at a contact portion between the external battery post portion and the internal battery post portion, wherein contacting the external battery post portion and the internal battery post portion permits current flow from the battery, wherein moving the external battery post portion and the internal battery post portion horizontally to a position in which the external battery post portion and the internal battery post portion are not in contact with each other via the switch contact post prevents current flow from the battery, and wherein the housing comprises at least one seal for isolating the internal environment of the housing from the environment external to the housing.

### BRIEF DESCRIPTION OF THE DRAWINGS

FIG. 1 is a cross-sectional view of the motor vehicle battery 100 with the internal terminal disconnect switch in the ON position.

FIG. 2 is a cross-sectional view of the motor vehicle battery 200 with the internal terminal disconnect switch in the OFF position.

FIG. 3 is a cross-sectional view of the internal terminal disconnect switch 300 in the OFF position.

FIG. 4 is a cross-sectional view of the internal terminal disconnect switch 400 in the ON position.

### DETAILED DESCRIPTION OF THE EMBODIMENTS

The following is a detailed description of certain specific embodiments of the battery disclosed herein. In this description reference is made to the drawings.

### DEFINITIONS

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

### INTRODUCTION

In one aspect, disclosed herein is a battery comprising an internal terminal disconnect switch for selectively preventing current flow from the motor vehicle battery, wherein the internal terminal disconnect switch comprises: a) an external battery post portion; b) an internal battery post portion; c) a housing; and d) a switch contact post capable of moving horizontally towards and between the external battery post portion and the internal battery post portion and making contact therebetween at a contact portion between the external battery post portion and the internal battery post portion, wherein contacting the external battery post portion and the internal battery post portion permits current flow from the battery, wherein moving the external battery post portion and the internal battery post portion horizontally to a position in which the external battery post portion and the internal battery post portion are not in contact with each other via the switch contact post prevents current flow from the battery, and wherein the housing comprises at least one seal for isolating the internal environment of the housing from the environment external to the housing.

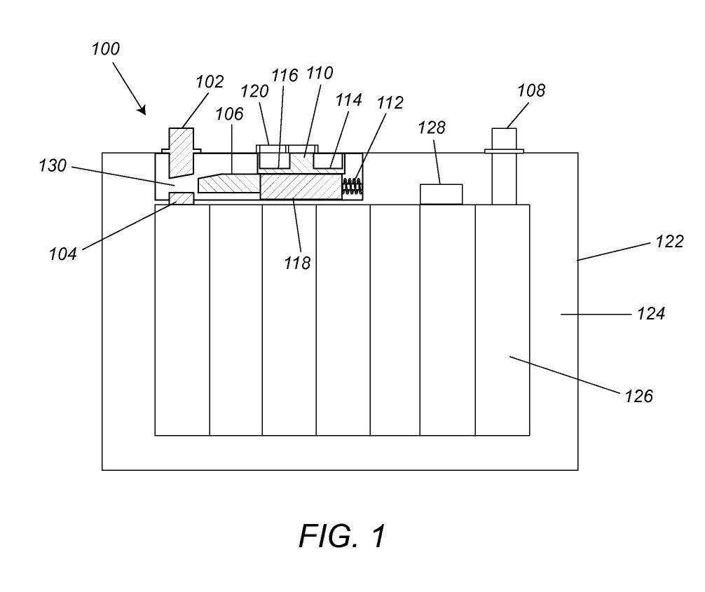

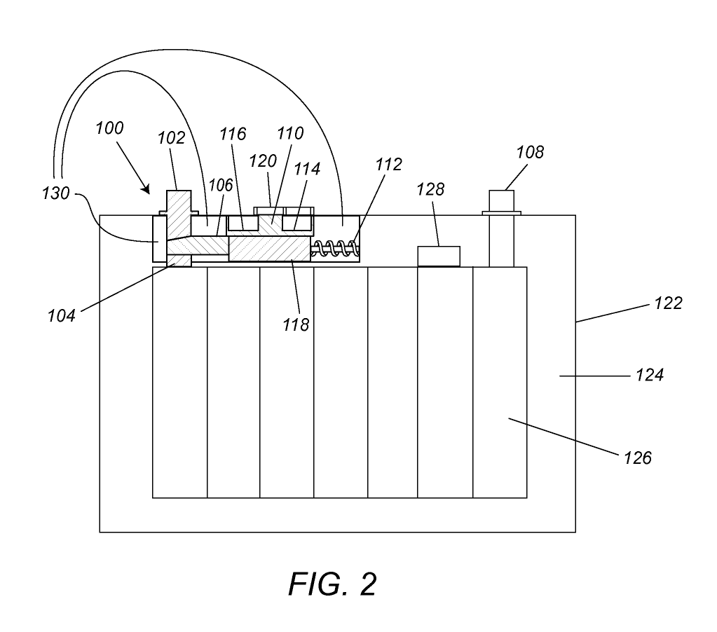

Referring to the drawings, FIGS. 1 and 2 illustrate a motor vehicle batteries 100 having an external housing 122, electrolyte solution 124, cell plates 126, internal terminal disconnect switch housing 118, internal battery post portion 104, seals 304, external battery post portion 102, manual control 110, sealed environment 130, opposite terminal 108, lid portion 120 and vent cap 128. In operation, manual control 110 is mechanically connected to a switch contact post 106 and allows a user to slide the switch contact post 106 horizontally, thereby revealing the green ON position indicator 114, so as to contact internal battery post portion 104 and the external battery post portion 102, thereby allowing current to flow from motor vehicle battery 200 to an external load (not shown). Seals 304 may be affixed to housing 118, internal battery post portion 104 and/or external battery post portion 102. As shown, the point of contact between internal battery post portion 104 and the external battery post portion 102 occurs in a sealed environment 130.

Alternatively, when motor vehicle battery 100 is to be stored for an extended period of time, manual control 110 allows a user to slide the switch contact post 106 horizontally, thereby revealing the red OFF position indicator 116, so as to not contact the internal battery post portion 104 and/or external battery post portion 102, thereby preventing motor vehicle battery 100 from discharging over time. In addition, when it is desired to connect an external load to battery 100 under enhanced safety conditions, manual control 110 allows a user to slide the switch contact post 106 horizontally so as to contact internal battery post portion 104 and the external battery post portion 102, thereby allowing a user to connect an external load to external battery post portion 102. In some embodiments, the external battery post portion and the internal battery post portion are arranged perpendicular to the horizontal movement of the switch contact post. In operation, spring 112 facilitates the horizontal sliding movement of the switch contact post 106 along a horizontal axis relative to the external battery post portion 102. This sequence of events completes the electrical circuit within sealed environment 130 rather than in an open, oxygen rich environment. In some embodiments, the sealed environment comprises an invert gas, wherein the invert gas is argon, nitrogen or another suitable inert gas. In some embodiments, the at least one seal is/are affixed to the housing. In some embodiments, the internal terminal disconnect switch comprises two seals affixed to the housing. In some embodiments, the at least one seal is/are affixed to the external battery post portion. In some embodiments, the at least one seal is/are affixed to the internal battery post portion. In some embodiments, the at least one seal is/are affixed to the contact portion. In some embodiments, the seals are grease, silicon, rubber, plastic or a combination thereof.

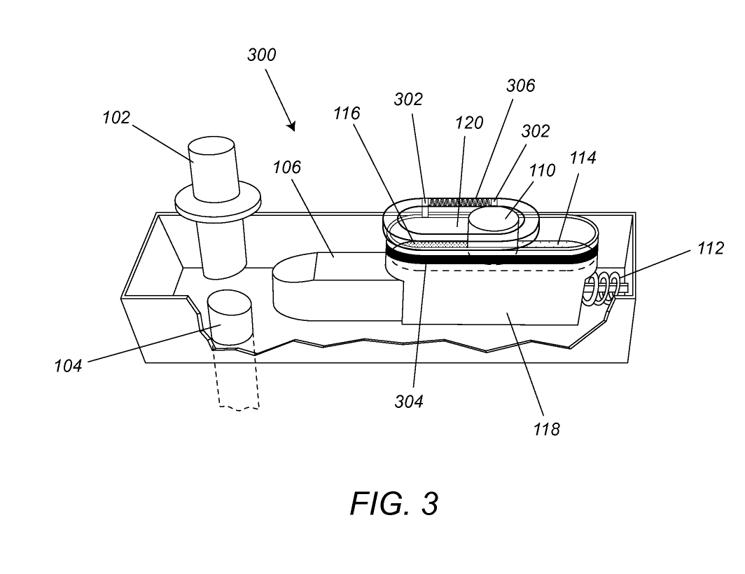

FIG. 3 illustrates an internal terminal disconnect switch 300 in the On position having an external housing 118, a switch contact post 106, internal terminal disconnect switch housing 118, internal battery post portion 104, seals 304, external battery post portion 102, manual control 110, sealed environment 130, opposite terminal 108, lid portion 120, at least one lid hinge 302 and lid spring portion 306. In some embodiments, the internal terminal disconnect switch further comprises a spring affixed to the housing, wherein the spring allows horizontal movement of said external terminal relative to said internal terminal. In some embodiments, wherein moving the switch contact post horizontally towards the contact portion to an ON position and in reverse to an OFF position comprises a manual control that is mechanically connected to the switch contact post. In some embodiments, wherein the internal terminal disconnect switch further comprises a lid portion covering the manual control to prevent accidental movement of the manual control to either an ON position, an OFF position or a position therebetween.

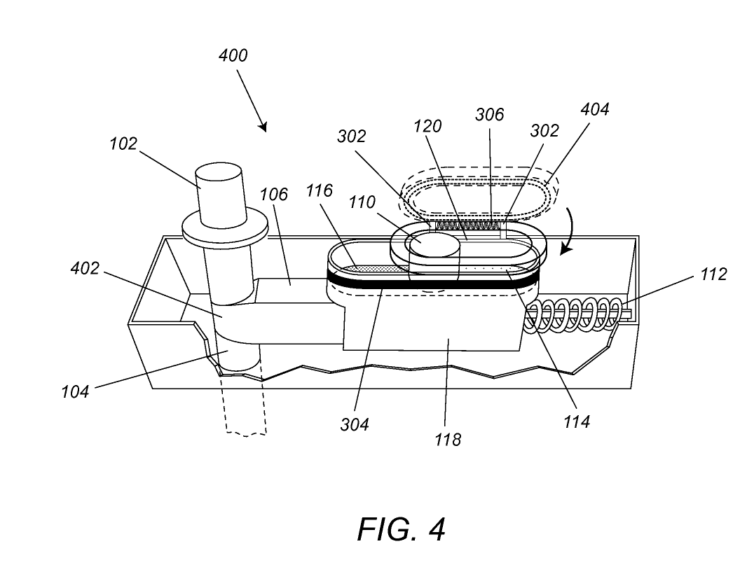

FIG. 4 illustrates an internal terminal disconnect switch 400 in the Off position having an external housing 118, a switch contact post 106, internal terminal disconnect switch housing 118, internal battery post portion 104, seals 304, external battery post portion 102, manual control 110, sealed environment 130, opposite terminal 108, lid portion 120, at least one lid hinge 302 and lid spring portion 306. In operation, a contact portion 402 is formed at the intersection of the switch contact post 106, internal battery post portion 104 and the external battery post portion 102. In some embodiments, the lid portion further comprises a lid seal 404.

In some embodiments, the battery is an automotive battery, motorcycle battery, ATV battery (all terrain vehicles), watercraft battery, wheelchair battery or a battery with battery terminals. In some embodiments, the battery is a wet cell battery, dry cell battery, molten salt, lead-acid automotive battery, VRLA battery (valve-regulated lead-acid batter), SLA (sealed lead-acid battery), gel cell VRLA battery or an AGM (absorbed glass mat) VRLA battery.

The presently disclosed batteries are not to be limited in scope by the specific embodiments described herein, which are intended as single illustrations of individual aspects of the presently disclosed devices and methods, and functionally equivalent devices, methods and components are within the scope of the presently disclosed batteries. Indeed, various modifications of the presently disclosed batteries, in addition to those shown and described herein will become apparent to those skilled in the art from the foregoing description and accompanying drawings. Such modifications are intended to fall within the scope of the appended claims.

All of the U.S. patents and published U.S. patent applications referred to in this specification are incorporated herein by reference in their entirety to the extent not inconsistent with the present description.

What is claimed is:

1. A battery comprising an internal terminal disconnect switch for selectively preventing current flow from the motor vehicle battery, wherein the internal terminal disconnect switch comprises:
a) an external battery post portion;
b) an internal battery post portion;
c) a housing; and
d) a switch contact post capable of moving horizontally towards and between the external battery post portion and the internal battery post portion and making contact therebetween at a contact portion between the external battery post portion and the internal battery post portion,
wherein contacting the external battery post portion and the internal battery post portion permits current flow from the battery, wherein moving the external battery post portion and the internal battery post portion horizontally to a position in which the external battery post portion and the internal battery post portion are not in contact with each other via the switch contact post prevents current flow from the battery, and
wherein the housing comprises at least one seal for isolating the internal environment of the housing from the environment external to the housing.

2. The battery of claim 1, wherein the internal terminal disconnect switch further comprises a spring affixed to the housing, wherein the spring allows horizontal movement of said external terminal relative to said internal terminal.

3. The battery of claim 1, wherein the external battery post portion and the internal battery post portion are arranged perpendicular to the horizontal movement of the switch contact post.

4. The battery of claim 1, wherein the at least one seal is/are affixed to the housing.

5. The battery of claim 4, wherein the internal terminal disconnect switch comprises two seals affixed to the housing.

6. The battery of claim 1, wherein the at least one seal is/are affixed to the external battery post portion.

7. The battery of claim 1, wherein the at least one seal is/are affixed to the internal battery post portion.

8. The battery of claim 1, wherein the at least one seal is/are affixed to the contact portion.

9. The battery of claim 1, wherein moving the switch contact post horizontally towards the contact portion to an ON position and in reverse to an OFF position comprises a manual control that is mechanically connected to the switch contact post.

10. The battery of claim 1, further comprising a lid portion covering the manual control to prevent accidental movement of the manual control to either an ON position, an OFF position or a position therebetween.
